(19) United States
(12) Patent Application Publication
(10) Pub. No.: US 2013/0339332 A1
(43) Pub. Date: Dec. 19, 2013

(54) News reporting system

(71) Applicant: Mark Ellery Ogram, Tucson, AZ (US)

(72) Inventor: Mark Ellery Ogram, Tucson, AZ (US)

(21) Appl. No.: 13/507,281

(22) Filed: Jun. 18, 2012

(51) Int. Cl. G06F 17/30

(52) U.S. Cl. 707/705; 707/E17.032

(57) ABSTRACT

A news collection and dissemination system which utilizes a central computer having a data base of articles which have been submitted by submitters/reporters (ideally eye witnesses) located at the site. Submission of the articles uses a first electronic mechanism (e.g. a laptop computer, a note pad, a desktop computer, a cellular telephone) linked with and communicating with the first computer. Ideally the first electronic mechanism is identified using a removable memory. The articles are selectively communicated to a second electronic mechanism which ideally is also identified using a removable memory.

### BACKGROUND

This invention relates generally to the Internet and more particularly to a system adapted to collect and disseminate news.

The Internet has provided a platform for the easy dissemination of news. The electronics and paper news agencies have almost uniformly started publishing their own Internet versions of their products. As such, the product hasn't changed much if any from the paper version.

Further, the established news agencies are extremely effective for national and international news where they have journalists following the “action” and writing stories; but, at the state and local levels, this approach is not feasible and as such, the reporting for the individual states and the many locales around the world is almost totally forgotten or ignored. The problem is that while the international and national news does have an effect on the individual's life, the local and state activities have a more direct affect and this under-reporting has caused problems.

It is clear there is a need for an improved local news collection and delivery system.

### SUMMARY OF THE INVENTION

The invention is a news collection and dissemination system. A central computer uses a data base of articles. These articles range from news, to sports, to classified, and anything else that is typically relevant to the locale.

The articles are created and submitted by people located at the site. As example, articles from San Diego are made by local residents who have seen something, heard of something, or otherwise have knowledge of an event. The local resident, by submitting the article, creates a fresher view as the item has just occurred and is able to give a true eye witness account.

The submission of articles utilize a variety of electronic mechanisms such as, but not limited to: laptop computers, note pads, desktop computers, cellular telephones and the like. With the use of any type of electronic mechanism for the submission, while the event is still fresh, it is put out onto the internet or other distributed system when it is deposited into a database controlled by the central computer for later distribution.

Ideally the operator of the electronic mechanism is uniquely identified using a removable memory to assure the source of the article.

Once the article has been stored in the memory of the central computer, other electronic mechanisms are able to access them. As example, in the article submitted in San Diego, a traveler from San Diego is able to keep current on the happenings even when they are in Bombay, India.

The operator of the receiving electronic mechanism, ideally is also uniquely identified using a removable memory. This allows the central computer to “learn” what the reader wants and to make suggestions on other relevant articles in the future.

In this context then, the present invention provide a coordinated data base at a central computer which is disseminated to interested parties in response to selections they have made.

Communicating data to remote computers, cell phones, and other electronic mechanisms is well known to those of ordinary skill in the art. These include: U.S. Pat. No. 8,185,940, entitled “System and Method for Providing Discriminated Content to Network Users” issued to Bowers et al. on May 22, 2012; U.S. Pat. No. 8,185,601, entitled “Sharing Information Between Devices” issued to Rauhala et al. on May 22, 2012; U.S. Pat. No. 8,185,617, entitled “TCP-Over-TCP Multiple TCP Streams” issued to Mukerji on May 22, 2012; U.S. Pat. No. 8,185,395, entitled “Information Transmission Device” issued to Ariyoshi et al. on May 22, 2012; and, U.S. Pat. No. 8,185,626, entitled “Methods for Transmitting Multipmedia Files and Advertisements” issued to Fernandez on May 22, 2012; all of which are incorporated hereinto by reference.

The data base is sorted as to a variety of classifiers such as locale (i.e. San Diego, area code 90210), type of article (i.e. opinion, news, traffic, crime), date (i.e. within the last hour, day), and even by key names (i.e. “Mayor Greenberg”). This allows the operator (“reader”) of the receiving electronic mechanism to sort through the articles for the ones of their interest. One such selection might take the form “San Diego Central High, football, last night”).

Selecting content from a database which is to be transmitted to a remote apparatus is well known in the art. These include such techniques as described in: U.S. Pat. No. 8,185,944, entitled “High-Assurance File-Driven Content Filtering for Secure Network Server” issued to Schnackenberg et al. on May 22, 2012; U.S. Pat. No. 8,185,918, entitled “Method and System for Managing Access to Add-On Data Files” issued to Meerwald et al. on May 22, 2012; U.S. Pat. No. 8,185,940, entitled “System and Method for Providing Discriminated Content to Network Users” issued to Bowers et al. on May 22, 2012; and, U.S. Pat. No. 8,185,961, entitled “Network System, Method for Controlling Access to Storage Device, Management Server, Storage Device, Log-In Control Method, Network Boot System, and Method of Accessing Individual Storage Unit” issued to Ichikawa et al. on May 22, 2012; all of which are incorporated hereinto by reference.

Once the articles have been identified, they are communicated to the “reader” using a variety of techniques well known to those of ordinary skill in the art, including, but not limited to those found in: U.S. Pat. No. 8,185,597, entitled “Providing Notifications to an Individual in Multi-Dimensional Personal Information Network” issued to Cumberbatch et al. on May 22, 2012; U.S. Pat. No. 8,185,598, entitled “Systems and Methods for Monitoring Messaging Systems” issued to Golovin et al. on May 22, 2012; U.S. Pat. No. 8,185,100, entitled “Communication System”issued to Jones et al. on May 22, 2012; and U.S. Pat. No. 8,185,302, entitled “Conversational Vehicle Routing” issued to Schunder on May 22, 2012; all of which are incorporated hereinto by reference.

An aspect of the invention permits the reporting entity (“reporter”) to classify the report as to their “degree of connection” to incident. These reports may take the form of:
( ) Involved in the Incident
( ) Eye Witness to the incident
( ) Heard about through a news agency
( ) Heard about it from an eye witness
( ) Heard about it through several parties

This allows the reader to do their own evaluation as to the accuracy of the report.

Another automatic check on the authenticity of the article involves an automatic check on location. The reporter of the article identifies the location when submitting the article (i.e. “New York City”) while the physical location of the reporting apparatus is also given (i.e.“Ethopia”). In this example, the two locations are not consistent so the article would be “flagged” for further analysis before it is posted. This cuts down on false reporting of facts.

Ideally the articles being submitted are “stamped” with a “shelf life” of how long the article will be of interest. This allows the central computer to clean out articles which are no longer relevant or of interest. As example, the announcement of a church barbeque this coming Sunday would be deleted on Monday; news on a criminal investigation may extend for several months.

Capturing the submitted article is well known to those of ordinary skill in the art. One such example is U.S. Pat. No. 8,185,959 entitled “Digital Rights Management of Captured Content Based on Capture Associated Locations” issued to Bellwood et al. on May 22, 2012, incorporated hereinto by reference.

In a similar manner, the “classifieds” are also time sensitive and ideally are posted only for a short period of time (i.e. a week). Further, the central computer monitors the classifieds and eliminates duplicates to prevent individuals from “flooding” the classifieds.

Articles are submitted with a classifier identifying the community which may be interested in the article. This classifier may extend from a neighborhood (typically identified by a zip code in the United States) to the entire state, or even a country or continent. As example, a robbery arrest would be of interest to the neighborhood, the status of a state bill would appeal across the state, civil war would be of interest to countries in the region.

In one aspect of the invention, the reporter is allowed to enter the report using natural speech. This natural speech is turned into digital text using a variety of techniques such as that described in U.S. Pat. No. RE43,406, entitled “Method and Device for Speech Analysis” issued to Clavbo on May 22, 2012; and U.S. Pat. No. 8,185,372, entitled “Apparatus, Method and Computer Program Product for Translating Speech Input Using Example” issued to Sumita on May 22, 2012; both of which are incorporated hereinto by reference.

The submission of the article is done via a variety of mechanisms including desktop computers, laptop computers, pads, and cellular telephones. This variety of input sources allows for instant rendering of the articles so that they are as fresh as possible.

When the article is submitted, photos and video are also ideally submitted in the preferred embodiment. In some embodiments, the central computer reviews the submitted article for a name of public official and then inserts a stock photo with identifier into the article to heighten the article's thoroughness.

Accessing the news articles is accomplished through computers, electronic pads, and cellular telephones, and other electronic equipment. The readers are also able, in some embodiments, to denote specific locations and have the articles instantly sent to them when the article is submitted. This permits the reader to stay abreast of developing news without having to log onto the central computer.

A reader is able to establish the locale they are interested in seeing news about. This identification may be the neighborhood (i.e. news associated with zip code 90078), a broader area (i.e. news associated with zip code 900??), or even broader with the state (i.e. news associated with California).

Additionally, the reader is also permitted to enter specific locales for the reporting of news items. As example, a merchant may want to know what is happening on the block where his store is. This would permit a report of a fire or riot to be instantly communicated to the merchant, allowing the merchant to take remedial action.

In some situations, the reporting of the news to the “reader” is done in an audible form wherein the article is transformed into synthetic speech.

Another technique of the present invention permits voice input to create the article. This allows the use of cellular phones for on the spot reporting of incidents. This reporting is often accompanied by a photograph or video (with sound) of the event, giving the reader an even more accurate representation.

Within the system, once the new report has been “published” on the screen, viewers are able to interact through a variety of levels. At a first level, the viewer is able to comment as to accuracy of the report and make adjustments or comments on later developments. This allows the news article to appear:
Report: THERE WAS A TWO CAR ACCIDENT ON FIRST AND MAIN. FIRE ENGINES ARE THERE BUT NO AMBULANCES. John Smith reporting 5:12 p.m.
Later Development: AMBULANCES ARRIVED LATER AND REMOVED A SINGLE OCCUPANT OF THE SEDAN. DOESN'T APPEAR TO BE ANY INJURIES TO THE OCCUPANTS OF THE TRUCK. Sarah Jones reporting 5:45 p.m.
Later Development: THE CARS HAVE BEEN REMOVED FROM THE INTERSECTION. Bill Johnson reporting 6:30 p.m.

This technique of using multiple reports is useful to fill in the original story's contents. This is done by using multiple eyewitness accounts. One such example might be:
REPORT: There was a shot fired at a white car from a man driving a red car on the corner of First and Elm. Henry Smith reporting 3:35 (eyewitness)
REPORT: The red car was a Dodge Charger. First part of license was ABC. Mary Johanson reporting 3:36 (eyewitness)
REPORT: Saw the Red Dodge Charger speed away, last part of license is 789. Hector Garcia reporting 3:36 (eyewitness)

In this manner, the full identity of the assailant's car is given, Red Dodge Charger, license ABC 789 while no single person collected all of the information.

Another interaction permits articles to be posted in one language allowing another participant to provide a translation into another language or languages. As example:
Report: Fue' una acidente en el centro. Juan Gomez 4:33 p.m.
Translation: There was an accident down town. Maria Sanchez 5:19 p.m.

Those of ordinary skill in the art readily recognize a variety of technologies which can be used in automatically translating a report. These include, but are not limited to: U.S. Pat. No. 8,137,105, entitled “Chinese/English Vocabulary Learning Tool” issued to Chen et al. on Mar. 20, 2012; U.S. Pat. No. 8,145,472, entitled “Language Translations Using a Hybrid Network of Human and Machine Translators” issued to Shore et al. on Mar. 27, 2012; U.S. Pat. No. 8,185,373, entitled “Method of Assessing Language Translation and Interpretation” issued to Messenger on May 22, 2012; all of which are incorporated hereinto by reference.

Another aspect of the invention permits the reporting to be done in natural speech. This allows the user to be engaged in other activities such as driving while still giving the report. One such technique used in this context is U.S. Pat. No. 8,185,380, entitled “Apparatus for providing Information for Vehicle” issued to Kameyama on May 22, 2012; incorporated hereinto by reference.

One aspect of the invention permits individuals to submit articles/reports “anonymously”. The submitter is not truly anonymous as the central computer knows the individual by a pass key (such as a USB key) which uniquely identifies the individual. The use of a pass key prevents an interloper from impersonating the properly authorized individual.

Because of the anonymous nature, more news articles are available allowing more information to be disseminated without the fear of reprisals. Such submissions may come from parties involved in the political arena, corporate whistleblowers, etc.

Ideally the pass key also encrypts the message/report which is only decrypted at the central computer. This also prevents hackers from viewing what is being passed along.

The anonymous submission also permits communication through the central computer between the anonymous submitter and a traditional news agency. This communication is ideal for a “whistle blower” to communicate with the news people without having to divulge their true identity and submit themselves to retribution from their employer or government agency.

In this situation, the news agency reporter is ideally also identified using the pass key approach so that the legitimacy of the party is easily verified.

Another use of the pass key is to permit only authorized people adjust or delete articles. Considered “editors”, these people have proven themselves as reliable and competent. “Editors” review the articles being submitted to screen for inappropriate items (i.e. pornography or slanderous material) and can delete these items; further the “editors” can also make grammatical and spelling corrections to the submitted articles.

An important aspect of the “editor” is the ability to ban a particular person from submitting articles once that person has repeatedly abused the system.

“Editors” are typically people from the community who have proven themselves with their veracity, skills, and generally a professional attitude.

Using the GPS location of the reader is also an advantage to screen out malicious comments and other such activities. As example, should a reader complain about an article claiming to be another eye witness and their GPS location is a continent away, their comments can be ignored.

Another aspect of the present invention is a unique methodology used to evaluate an article either for its accuracy or for its acceptable content. If an article has been “challenged” by a reader, a number of “editors” or trusted individuals are chosen at random to evaluate the article. The article is sent to the editors together with the reader's comments. Each of the editors is then able to give a thumbs up/down opinion on whether to keep the article posted or not.

If the result is a “thumbs down”, then the article is removed from posting; if the result is a “thumbs up”, then the fact that the article was vetted is noted on the article.

Within the present invention, the posting of advertising is important. Ideally, within the present invention, advertising done with the posting is short and provides a link to a webpage or a full advertisement for the merchant. As example, the advertising for Martoni's Italian Restaurant would show a logo and the “Martoni's Italian Restaurant, voted best in Buffalo three years running” allowing the reader to click on the name and then be linked to the full Martoni page.

In another embodiment, when the Martoni is clicked, an advertisement is pulled from the Martoni page and presented to the reader while maintaining their position on the news computer's page.

Another aspect that the present invention uses is that when the Martoni full advertisement is shown, a printable discount coupon (if available for Martoni), is also displayed to induce the reader to try Martoni's.

The selection of advertisements to accompany a particular article is a technology well known in the art and include such methods as those described in: U.S. Pat. No. 8,185,923, entitled “System and Method for Selecting Advertisement” issued to Slaney et al. on May 22, 2012; U.S. Pat. No. 8,185,967, entitled “Method and Apparatus for Content Management” issued to Levy on May 22, 2012; both of which are incorporated hereinto by reference.

The invention, together with various embodiments thereof will be more fully explained by the accompanying drawings and the following descriptions thereof.

### DRAWINGS IN BRIEF

FIG. 1 is a block diagram of the preferred embodiment of the invention in use.

FIG. 2 is a flowchart of the preferred operation for input of an article.

FIG. 3 is a flowchart of the preferred operation for the communication of an article to a requester/reader.

FIG. 4 is a flowchart of the preferred operation for authenticating voice input of an article.

FIGS. 5A and 5B are screens of the preferred embodiment's interaction for the submission of an article.

FIGS. 6A and 6B are screens of the preferred embodiment's interaction for the release of an article to a reader.

FIG. 7 is a flowchart of the preferred operation to remove “stale” articles.

FIG. 8 is a flowchart illustrating the preferred embodiment's handling of a “challenged” article.

### DRAWINGS IN DETAIL

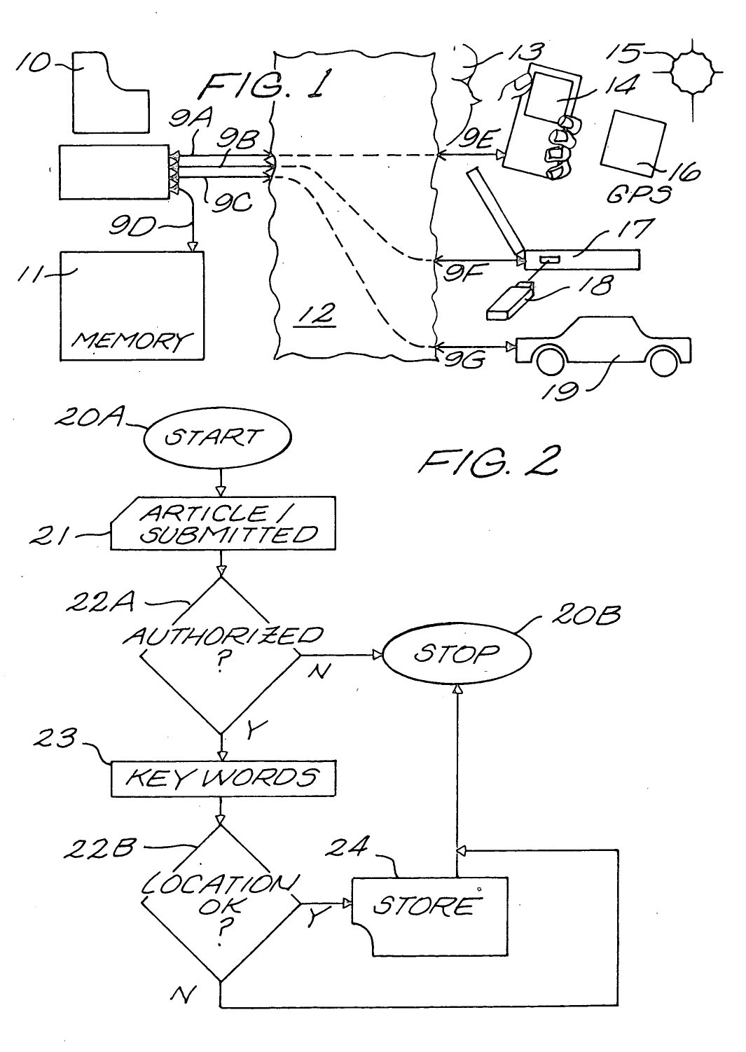

FIG. 1 is a block diagram of the preferred embodiment of the invention in use. Central computer 10 collects and disseminates the information/articles to the various electronic devices. In this illustration, the Internet 12 is illustrated as the distribution system but the invention is not so limited and includes any system for the dissemination of digital information.

The articles are stored in memory 11 which communicates with the central computer 10 via link 9D. Central computer 10 maintains these articles and is able to sort through them to collect and disseminate articles germane to the reader's search.

The creation of the article is via an electronic apparatus, a cellular telephone 14 in this illustration, which accepts the input from operator 13 who is an eye-witness to event 15. Event 15 is intended to include any reportable event, such as but not limited to: traffic, city hall activities, sporting events, and many more obvious to those of ordinary skill in the art.

In the preferred embodiment, the location of cellular telephone 14 is established using GPS 16. The location data as automatically collected and is communicated together with the article via link 9E and Internet 12 to the central computer 10 and link 9A.

The article is “screened” by the central computer 10 to assure that the article is reliable. This is done through a variety of techniques well known to those of ordinary skill in the art. One such technique utilizes the GPS 16 data associated with the article to assure that the article is truly being made by an eyewitness (e.g. checks for the reporter being in the same area as the event).

Further, a memory chip (not shown) within cellular telephone 14 contains an identification of the user 13 which is used by central computer 10 to determine that it is user 13 who has made the report.

The now vetted article is stored in memory 11 which contains other eyewitness articles.

A remote user of lap top computer 17 is able to request a certain category of articles from central computer 10 using link 9F and Internet 12 and link 9B. This request may be all articles relating to a particular locale, “everything from Bombay, India”, or more defined as to “church announcements from Oakland Calif.”.

Lap top computer 17, in the preferred embodiment, is identified using memory chip 18 which uniquely identifies the user. In some applications, memory chip 18 is a generic type of chip giving access to a broad group of users.

In this way, the user of lap top 17 is able to get local eyewitness news articles regardless of where the user is. As example, a traveling vendor is able to check on a flood occurring in their hometown even when they are continents away.

In a similar fashion, automobile 19 is able to link with central computer 10 using link 9G via Internet 12 and link 9C to collect relevant information. As example, while traveling a driver of automobile 19 is able to keep pace with the high school sporting event occurring in their home town.

FIG. 2 is a flowchart of the preferred operation for input of an article from a remote electronic apparatus to the central computer.

To input an article, the program starts 20A and the article together with various data is submitted to the central computer as outlined above. The data which is provided with the actual article includes such items as report designated location, a suggested title, who the submitter/reporter is, and in the preferred embodiment, the GPS coordinates.

This material is then analyzed 22A to see if the article is authorized for acceptance by the central computer. This analysis involves matching the reporter to the identification and possibly screening for improper or insulting racial/religious terms. In the preferred embodiment, the GPS coordinates are used to assure that the location supplied by the reporter is not bogus (i.e. the GPS says that it is India while the location given by the reporter is Vail, Colo.).

If the authorization 22A is negative, then the program stops 20B. If authorized 22A, then the key words are pulled from the article 23. The keywords are kept in a header of the article and are used by the central computer in finding sought after articles.

A test of the location is performed 22B which if negative, the program stops 20B; if the location is acceptable, the article together with its header information is stored in memory 24 and the program stops.

In this manner, the article is vetted and stored with a header that assists in finding the article later.

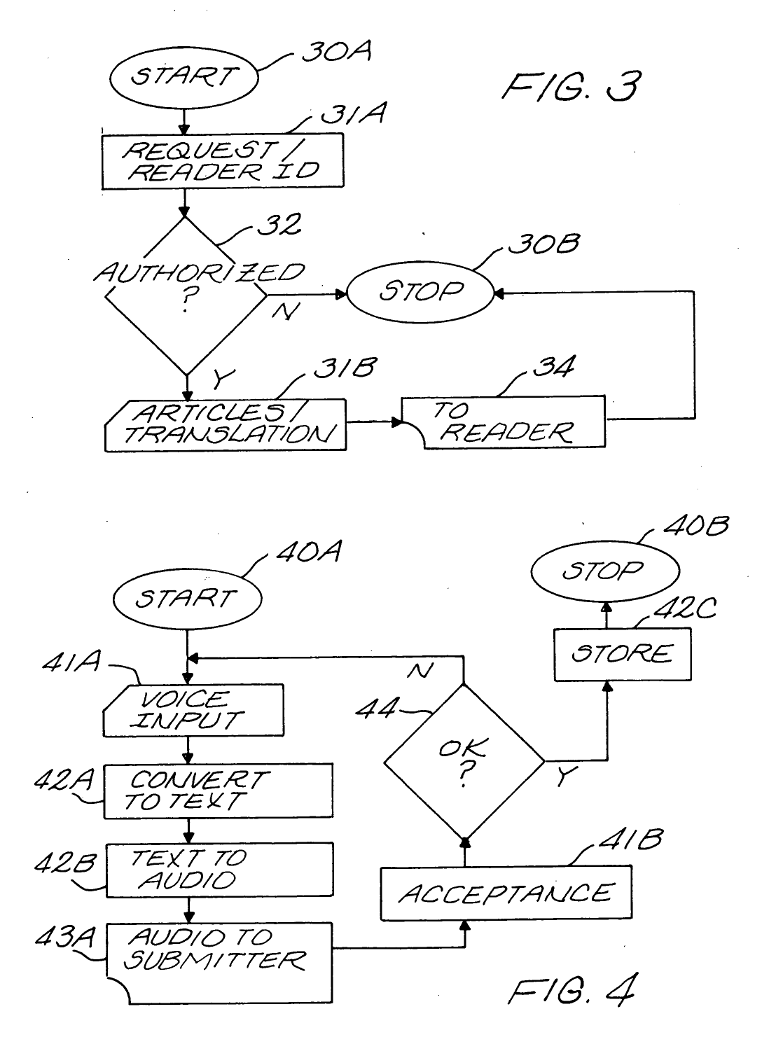

FIG. 3 is a flowchart of the preferred operation for the communication of an article to a requester/reader.

The central computer, in finding an article starts 30A and receives the request 31A from the reader. The request contains the reader's identification which ideally has been stored on the memory of the electronic apparatus.

The reader's identification is checked to see that the reader is authorized 32; if not, then the program stops 30B.

The check for the reader's identification is also useful in screening articles and advertisements which are intended for mature reader's only. Young readers are given identifications which preclude such mature subjects.

If the reader is authorized 32, then the articles and any associated translations are pulled from memory 31B and sent to the reader 34. The program then stops 30B.

In the preferred embodiment, the identification of the reader includes a preferred language and if the article is in a foreign language, a translation is provided. Ideally, both the original report and the translated report are provided to the reader. This allows the reader to check the veracity of the translation should they chose to do so.

FIG. 4 is a flowchart of the preferred operation for authenticating voice input of an article.

The acceptance of voice reports poses a particular problem for assuring accuracy. The embodiment of this invention which accepts verbal or voice reporting adds a closed loop verification process.

Once the program starts 40A, the voice report is received 41A and is converted into digital text 42A. As noted above, there are various methods well known to those of ordinary skill in the art for converting voice to text.

Once so converted to text, the text is re-converted to audio 42B using a variety of well known techniques defined above and is presented to the reporter 42A. The reporter is able to indicate an “acceptance” by input 41B. This four step process (voice-text; text-audio; present; accept) gives the reporter the ability to verify that what they thought was being reported is actually what will appear in text.

Often the voice is distorted due to stress or background noise can cause a faulty voice to text conversion. This process allows for correction.

If the text is acceptable 44A, it is stored 42C for later retrieval as noted above. The program stops 40B.

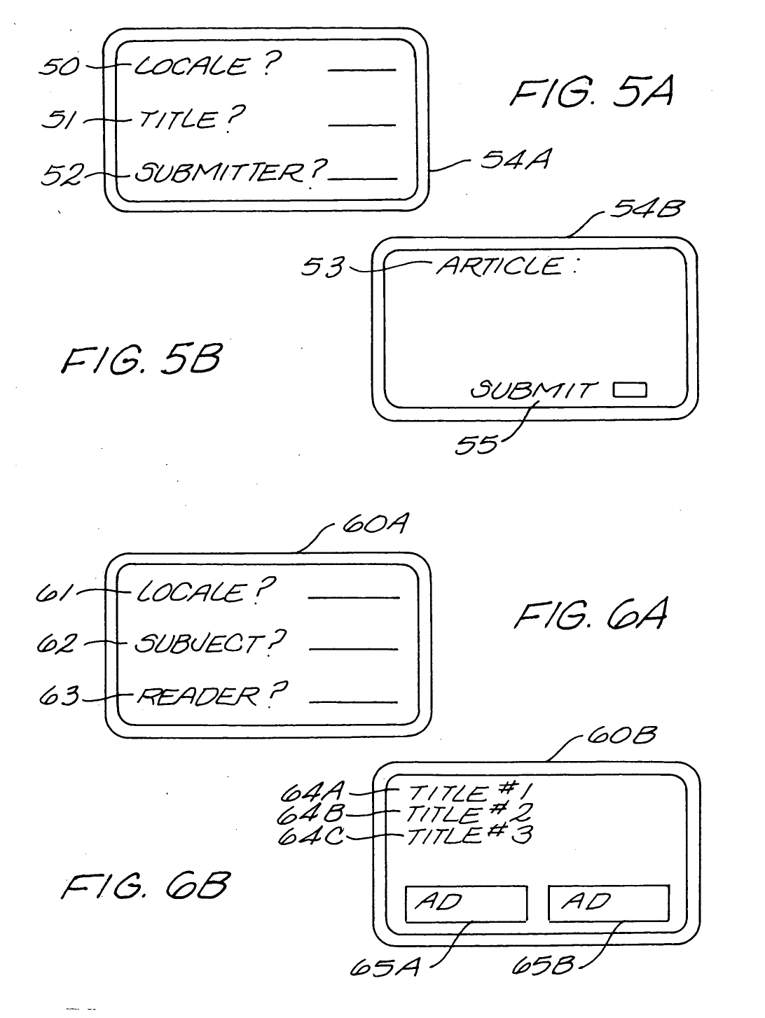

FIGS. 5A and 5B are screens of the preferred embodiment's interaction for the submission of an article.

Referring to FIG. 5A, screen 54A initially presents three “blanks” for the reporter to complete before the creation of the article. This is the “locale” 50, the “title” 51, and the “submitter” identification 52. This data provided by the reporter is used for the header information on the stored article and is also used to verify the reporter's identity and position to verify the authenticity of the article.

As shown in FIG. 5B, the screen changes to 54B allowing the reporter to create the “article” 53 and when completed to hit the “submit” button 55.

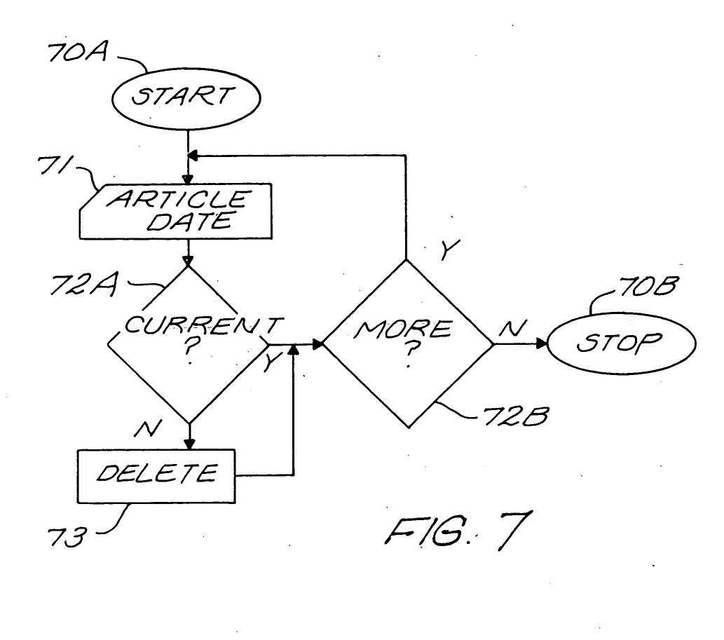

FIGS. 6A and 6B are screens of the preferred embodiment's interaction for the release of an article to a reader.

In requesting a group of articles, the reader is presented with screen 60A of FIG. 6A. The reader supplies a request for the “locale” 61 and a “subject” 62 to the central computer together with the identification of the “reader”. If the “subject” 62 is left blank, then all articles for the locale are supplied in the preferred embodiment.

As shown in FIG. 6B, the screen changes to 60B in response to the request shown in FIG. 6A, a listing of titles 64A, 64B, 64C is presented for the reader to choose by clicking on one of them.

Screen 60B is also provided with advertisements 65A and 65B.

FIG. 7 is a flowchart of the preferred operation to remove “stale” articles.

Periodically the central computer removes articles from the data base. This is done in the preferred embodiment by reviewing each of the articles therein.

In this embodiment, the program starts 70A and pulls an initial article from memory 71. A check on if the article is “current” 72A and if it is not, it is deleted 73; if the article is “current” 72A, then the program determines if more articles need to be reviewed 72B and pulls the next one or stops 70B when all of the articles have been reviewed.

Another method for “cleaning” the data base is more passive in that an article, when requested by a reader, as outlined in FIG. 3, is checked to see if it is current and deleted from memory if it is not. In this methodology, there isn't an active “cleaning” of the data base but is done as articles are withdrawn

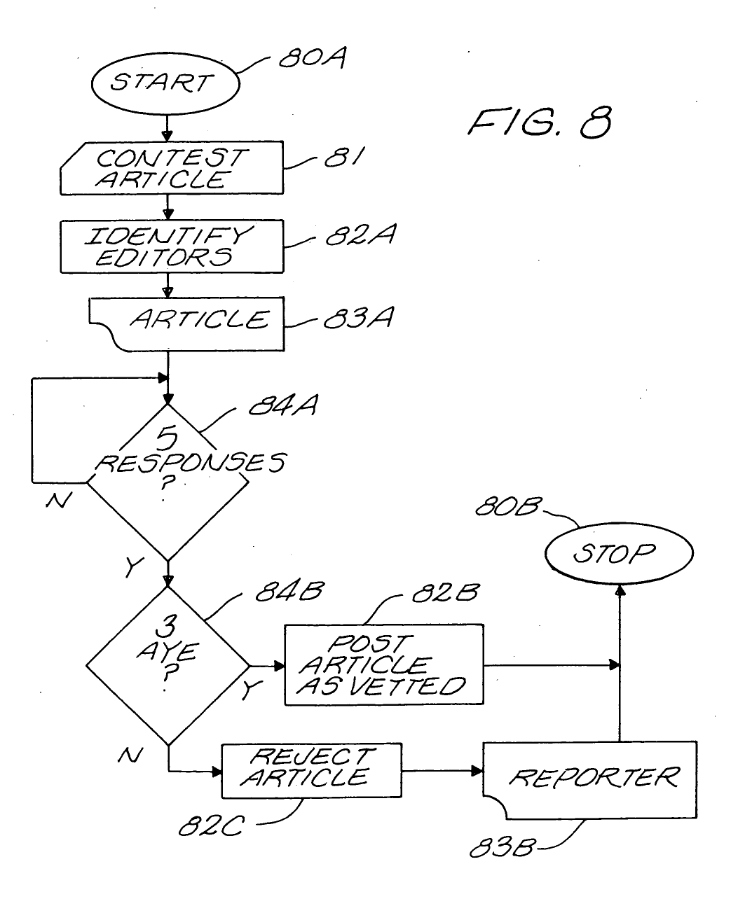

FIG. 8 is a flowchart illustrating the preferred embodiment's handling of a “challenged” article.

At times, a reader will contest an article for its facts or other concerns. In this situation, the reader is able to “contest” the article and give reasons for the contesting. The preferred technique for handling this type of situation is to employ other reporters as screeners.

Once the program starts 80A, the points contesting the article are received 81 from the complaining reader. In some situations, the article is “tagged” as receiving a complaint allowing another reader to be warned with the ability to read the actual complaint.

A random group of reporters/editors are chosen (typically ten in total) 82A and the complaint together with the article itself is sent to each of reporter/editors for comment 83A.

A check is made if five responses have been received 84A on the complaint. If three of the five reporter's response indicate an “aye” (agreement with the article” 84B), then the article is posted and listed as vetted so that future readers know that the article has been “cleared” by the editors/reporters.

If instead of three “aye” there are three “nays”, indicating that the editors/reporters agreed with the complaint 84B, the article is rejected 82C (removed from the data base) and the originating reporter is informed 83B of the removal of the article and the program stops 80B.

It is clear that the present invention provides for a highly improved system for the dissemination of news articles.

What is claimed is:

1. A news collection and dissemination system comprising:
a) a central computer having a data base of articles;
b) a first electronic mechanism linked with and communicating with the central computer an article, said first electronic mechanism having a first removable memory associated therewith, said first removable memory containing data uniquely identifying an operator of the first electronic mechanism; and,
c) a second electronic mechanism linked with and communicating with the central computer, said second electronic mechanism having a second removable memory associated therewith and containing data therein uniquely identifying an operator of the second electronic mechanism, and,
wherein said central computer selectively communicates the article to the second electronic mechanism.

2. The news collection and dissemination system according to claim 1, wherein said second electronic mechanism communicates data indicative of a physical location of the second electronic mechanism to the central computer and wherein said central computer selects the article based upon said data indicative of the physical location of the second electronic mechanism.

3. The news collection and dissemination system according to claim 2, wherein the data indicative of a physical location is generated automatically by the second electronic mechanism.

4. The news collection and dissemination system according to claim 1,
a) wherein the article associated with the first electronic mechanism includes data on a location associated with the article; and,
b) wherein the first electronic mechanism automatically communicates data on the physical location of the first electronic mechanism.

5. The news collection and dissemination system according to claim 4, wherein a flag is associated with the article if the data on the location of the first electronic mechanism is not within a defined radius of the data on the physical location of the first electronic mechanism.

6. The news collection and dissemination system according to claim 2, wherein said second electronic mechanism communicates data indicative of a preferred language and wherein said central computer automatically translates the article into the preferred language.

7. The news collection and dissemination system according to claim 6, wherein said article is communicated in both an original language of the article as well as a language associated with the second electronic mechanism.

8. The news collection and dissemination system according to claim 1, wherein said central computer deletes articles from the data base after a defined period of time.

9. The news collection and dissemination system according to claim 1, wherein the central computer includes speech recognition capability and wherein the central computer generates the article from oral speech received from the first electronic mechanism.

10. The news collection and dissemination system according to claim 1, wherein said central computer includes the capability to link articles within the data base.

11. The news collection and dissemination system according to claim 10, wherein input from the second electronic mechanism is stored in the data base and a link to the article is established therein.

12. The news collection and dissemination system according to claim 1, wherein the central computer includes the capability to translate an article into a second language and present an original and translated copy to the second electronic mechanism.

13. A news collection and dissemination system comprising:
a) a central computer having a data base of articles, said articles being completely composed by an eyewitness to an event substantially contemporaneously with the event and sorted by locale within the data base;
b) a first electronic mechanism linked with and communicating with the central computer an article for storage in the data base of articles.

14. The news collection and dissemination system according to claim 13,
a) wherein said first electronic mechanism includes an audible input mechanism and wherein an audio file is communicated by the first electronic mechanism to the central computer; and,
b) wherein the central computer translates said audio file into alphanumeric data.

15. The news collection and dissemination system according to claim 14,
a) wherein the central computer translates the alphanumeric data to an audible form and communicates the audible form to the first electronic mechanism; and,
b) wherein the first electronic mechanism, in response to an operator input, communicates an indicia of an acceptance of the audible form.

16. The news collection and dissemination system according to claim 13, further including a second electronic mechanism linked with and communicating with the central computer, said second electronic mechanism receiving articles from the data base via the central computer.

17. The news collection and dissemination system according to claim 16, wherein said second electronic mechanism communicates data indicative of a physical location to the central computer and wherein said central computer selects the article based upon said data indicative of a physical location.

18. The news collection and dissemination system according to claim 17,
a) wherein the article associated with the first electronic mechanism includes data on a location associated with the article; and,
b) wherein the first electronic mechanism automatically communicates data on the physical location of the first electronic mechanism.

19. The news collection and dissemination system according to claim 18, wherein said article is communicated in both an original language of the article as well as a language associated with the second electronic mechanism.
